(19) United States
(12) Patent Application Publication
(10) Pub. No.: US 2017/0140859 A1
(43) Pub. Date: May 18, 2017

(54) Magnetic field force energy/water

(71) Applicant: Yaakov Elchonon Oppen, Baltimore, MD (US)

(72) Inventor: Yaakov Elchonon Oppen, Baltimore, MD (US)

(21) Appl. No.: 14/943,677

(22) Filed: Nov. 17, 2015

(51) Int. Cl. H01F 7/02

(52) U.S. Cl. CPC H01F 7/0278

(57) ABSTRACT

This invention works by counter-weighting any kind of magnetic field in all ways known, either by/from itself or by intercepting it, or with electricity, using physics, and/or a preferably slimmer metal/magnet when intercepting the field. It will create electricity when the metals are induced with magnetic force or a movement of a power greater then used when the magnetic force reunites with the metals, all done via counterweight either of itself or by using physics to intercept with a metal/magnet the field or with electric energy changing the shifts of the magnetic field, or ways of chemistry. In all cases at least one of the magnets/metals that are in the field will be attached to all ways of making energy from movement. This will create energy and clean water because when the magnetic field renews its former position then movement/inducement of greater energy will be created.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATED BY REFERENCE OF MATERIAL SUBMITTED ON A COMPACT DISC OR AS A TEXT FILE VIA THE OFFICE ELECTRONIC FILLING SYSTEM (EFS WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

This patent pertains to making clean (portable) energy and electricity and clean water by using magnetic fields. This patent proves that with the use of magnetic fields you can make clean (portable) energy and electricity and clean water, for and with much less energy/power then it was previously thought.

It is based on intercepting and renewing the magnets strength and force in the magnetic field. Description of related art including information disclosed under 37cfr1.97 and 1.98 is not applicable

### BRIEF SUMMARY OF THE INVENTION

This patents concept is based on intercepting a magnets hold on the gravity it previously held, to create energy and movement, when the magnet's force goes off and on of the facing magnet in the magnetic field. However it can also be done by intercepting and then renewing the magnetic force on the facing metal/magnets. This patent tries to prove that this can both make (portable) clean energy and clean/heat water, as the energy previously thought it would take to do this, will be proven wrong, and that much less energy is needed. This patent is against what was formerly believed as not true and tries to prove against what was always understood as facts of physics. It is a way to make energy from the force of a magnetic field by intercepting it from its facing metal/magnet and then renewing it again. When the magnet renews the force on the facing metal/magnet movement or electricity will be created of a greater force then the energy used to make that interception, thus creating a fantastic and everlasting battery or vehicle and machine movement and even a way to heat up water. The movement of the metal/magnets will be connected to all known ways of creating energy from movement like to the generator using magnets or to vibration or by rubbing all things that create heat that can also be insulated to make energy using the thermo couple or by heating water or gasses in to steam for pressure or by any other way of movement making and causing energy, known now or in the future. This mechanism will also be a great way to clean water by heating it or sifting it or any other way, for fields and to drink etc. . . . . The patents concept of making energy is based on intercepting and then renewing a magnets magnetic force on the facing metal/magnets. The interception of the magnetic field will most preferably be done by way of physics such as counterweight or in different ways of using electric voltages of electricity but it can also possibly maybe be done with chemistry. So although I am going against what was an earlier fact of physics to many, please bear with me in my explanation of this new way of energy. The teaching of this patent is, that we can intercept a magnets force in a magnetic field from the metals/magnets it was facing for and with less energy use then that magnetic field will create. This will create movement or inducement from the interceptions and renewals of the magnetic force in the magnetic field. Every one knows that movement can make electricity in many many ways. In the cases I present we use the understanding in physics of the counterweight to bring about this thing. This patent will also help in cleaning water or other vehicle movements as understood.

### BRIEF DESCRIPTION OF THE SEVERAL VIEWS OF THE DRAWINGS

The accompanying drawings, which are incorporated into and form a part of the disclosure, illustrate embodiments of the invention and, together with the description, serve to explain the principles of the invention.

FIG. 1 shows is a schematic drawing of the magnetic field force energy/water device with a magnet facing a magnetic field being intercepted, with gravity.

FIG. 2 is a schematic drawing of the magnetic field force energy/water device with a electric generator that's magnets cause the attraction of the metals.

FIG. 3 is the schematic drawing of the magnetic force field energy/water device, that intercepts the magnetic field via counterweight of a set magnet that's force up is same as the force down.

FIG. 4 is a schematic drawing of the magnetic field force energy/water device with the intercepting magnetic force piece being helped from the top counterweighted to that same power.

FIG. 5 is a schematic drawing of the magnetic field force energy/water device, where the metals being induced are intercepted from each other and the magnets inducing electric can move and induce with very little power as it is counterweighted to go forward.

FIG. 6 is a schematic drawing of the magnetic field force energy/water device, where the intercepting piece or pieces are always held under the same pressure and force.

FIG. 7 is a schematic drawing of the magnetic field force energy/water device, where the magnets are in and also go back and forth in a/the counterweight, and a piece of steal has metals on the other side.

FIG. 8 is a schematic drawing of the magnetic field force energy/water device, where a magnet rolls attached to metals and inducing metals in all the ways.

FIG. 9 is a schematic drawing of the magnetic field force energy/water device, where a magnet is maneuvered towards metals and falls down attached to a generator with the metals going away.

FIG. 10 is a schematic drawing of the magnetic field force energy/water device, where a counterweight is used on a magnet to intercept with magnets the magnetic field.

FIG. 11 is a schematic drawing of the magnetic field force energy/water device, where electricity of an electro magnet that's preferably set not to have a jump in electricity, changes the magnetic field, by lifting and dropping the metals it was facing.

FIG. 12 is a schematic drawing of the magnetic field force energy/water device, where a metal carrying one of the electric forces of proton or neutron intercepts a magnetic filed.

FIG. 13 is a schematic drawing of the magnetic field force energy/water device, where electricity of an electro magnet that goes off/on is used to intercept a facing intercepting magnet in the magnetic field or vise versa.

### DETAILED DESCRIPTION OF THE INVENTION

This patent is against what was formerly believed as not true and tries to prove against what was always understood as facts of physics. It is a way to make energy from the force of a magnetic field by intercepting it from its facing metal/magnet and then renewing it again. When the magnet renews the force on the facing metal/magnet movement or electricity will be created of a greater force then the energy used to make that interception, thus creating a fantastic and everlasting battery or vehicle and machine movement and even a way to heat up water. The movement of the metal/magnets will be connected to all known ways of creating energy from movement like to the generator using magnets or to vibration or by rubbing all things that create heat that can also be insulated to make energy using the thermo couple or by heating water or gasses in to steam for pressure or by any other way of movement making and causing energy, known now or in the future. This mechanism will also be a great way to clean water by heating it or sifting it or any other way, for fields and to drink etc. . . . .

The patents concept of making energy is based on intercepting and then renewing a magnets magnetic force on the facing metal/magnets. The interception of the magnetic field will most preferably be done by way of physics such as counterweight or in different ways of using electric voltages of electricity but it can also possibly maybe be done with chemistry. So although I am going against what was an earlier fact of physics to many, please bear with me in my explanation of this new way of energy.

The mechanism has any kind of a magnet with a magnetic force which can be intercepted by way of a counterweight. This will intercept the magnetic force from the facing metal/magnet it is/was maneuvering or inducing. This counterweight can be created by the usage of different things in physics known to have a force of gravity that will be attached to the facing metal and magnet such as a spring, including any kind of spring or weights set to be added, meaning to get more and/or heavier with closer proximity (like with a chain), or with magnets opposing each other or attracting, or elastic, or air or water pressure or any thing known in the field of physics to have a push and pull force. When either one of the two facing metal/magnets get a small push from either side, which itself can be aided with a counterweight, or wheels, it/this will create movement and energy greater then what energy was used to make that push.

Because when the magnet losses its grip, gravity or the gravity making things will take over and movement will be created of as much force the magnet could earlier hold.

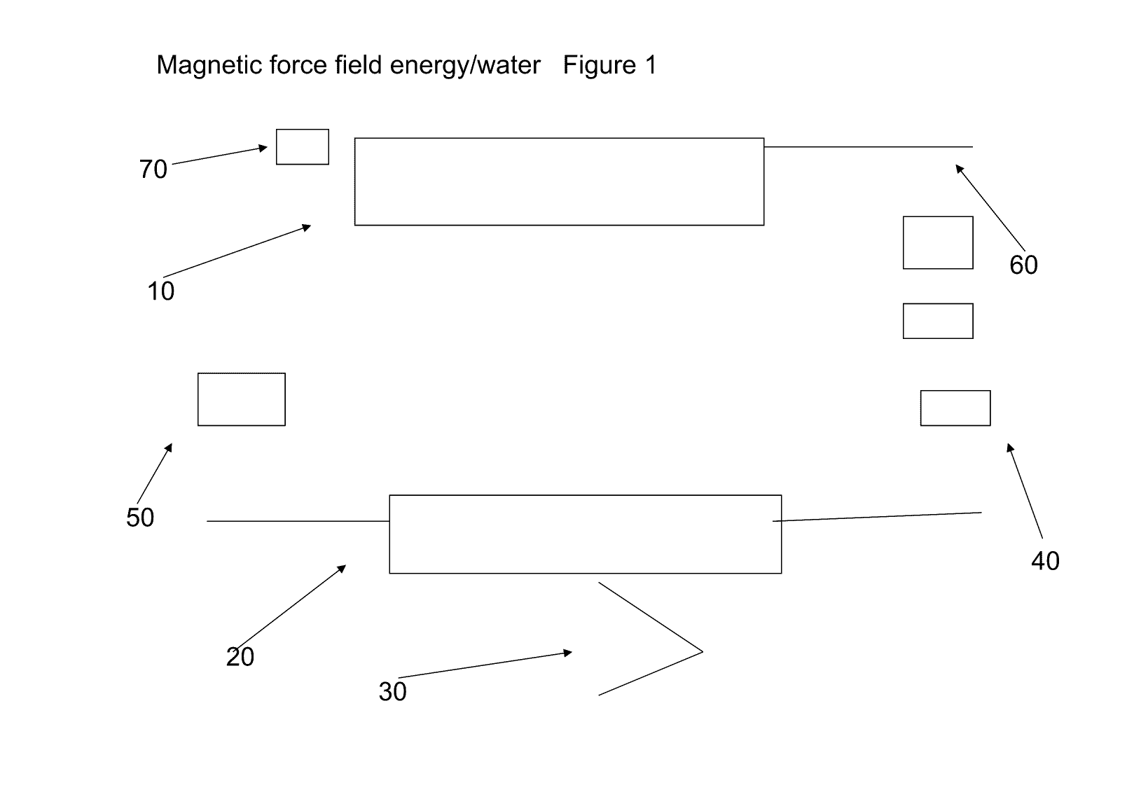

The energy needed to push to separate and to intercept that field was small because of the gravity things holding back and helping such as in a counterweight. When the magnet again renews its earlier position of strength on the facing metal/magnet this movement will resume another time. This movement of the metal/magnets will be connected to a/the generator in any way of connection to make energy or to [pumping/sifting or] making water clean or heated as explained. It has a metal/magnet facing a metal/magnet and a spring, or weights set to get added and/or heavier with closer proximity or magnets, and something to give it a small push on top either way or a small weight to push the metal down. View FIG. 1 where you will see [it has] a metal/magnet 10 facing a metal/magnet 20 and a spring 30, or weights set to get added and/or heavier with closer proximity 40 or magnets 50 and something to give it a small push on top either way 60 or a small weight to push the metal down 70. Remember this case for later, in proving all the ways it can be done on like 0 energy use.

The same concept is in a generator itself having the metal or magnets attached to springs etc. . . . or to a smaller magnetic generator inside, and the moving of the metal/magnet on and off the metal/magnets counter-weighted inside a generator. However I am still not sure if it doesn't use up electric force. Also the other one I guess I didn't yet write in is if there are many hands connected in a generator, set up in place and facing many magnets helping the pull out of the metal's from the magnets at once. This possibly was not done before me because it is the same as one hand, in inducement of energy, that you can't do 2 things at once, I must find out. Yet with my invention, it might work. It has a metal/magnet and springs or a smaller generator, and/or magnets and many metal/magnet hands so they are counter-weighted in the generator etc. . . . and move.

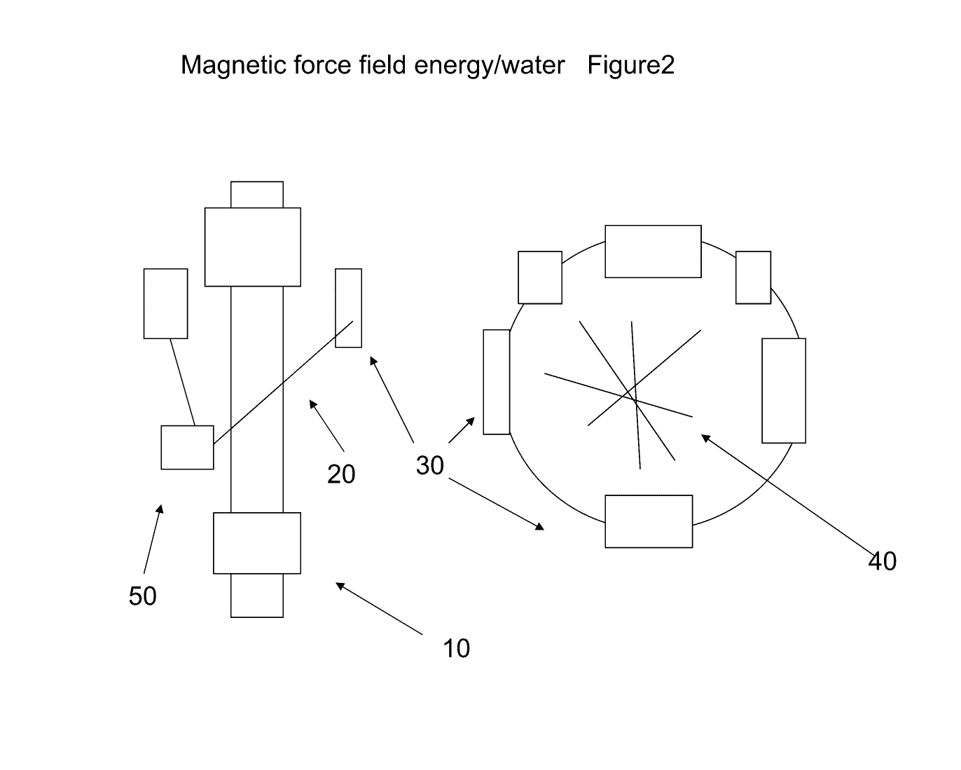

View FIG. 2 where you see a metal/magnet 10 and springs or a smaller generator 20 and magnets 30 and many metal/magnet hands 40 so they are counter-weighted in the generator etc. . . . and move 50.

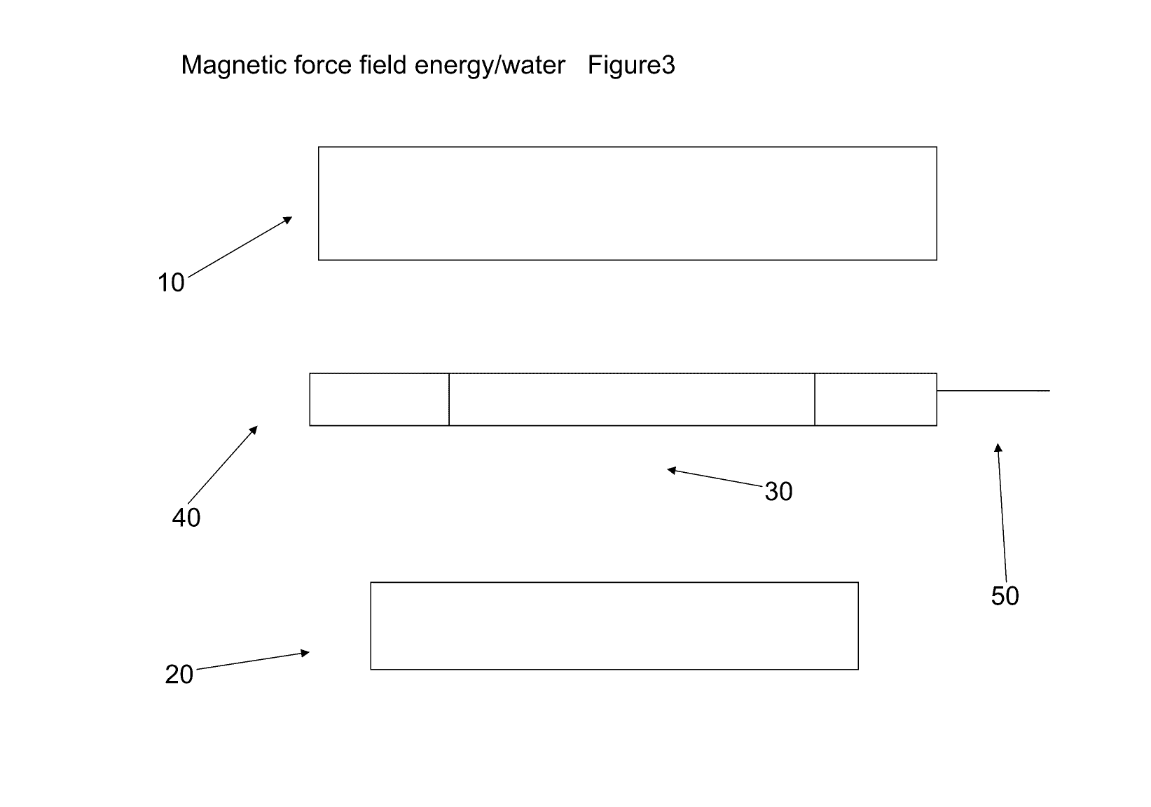

A even better way to intercept the magnetic field is by making a metal/magnet piece that will be made in such a way that the same force of it, [this intercepting metal piece] being pushed upwards will be the same force of it being pushed downwards thus it is a counterweight in physics and it will intercept the magnetic field in all the ways obvious according to what it is intercepting. This will be one strong piece but it will be made up of 2 or 3 or more pieces inside of it, in the electricity, biology/chemistry and atoms of the piece by and with the differences of north pole and south pole. This can also be the way the main magnet or magnets are made also, for it is the same thing, and it will be intercepted with a magnet etc. . . . . This will also work because in the laws of magnetism even though the thicker the magnet the stronger the pull but to intercept this magnetic force field, it can be done with a slimmer magnet provided it is/be made of the same strength or cut from a magnet of the same strength. The most obvious and probably the best way to make this intercepting piece [or the main magnet[s] would be by measuring the magnets size and then to connect it to a 2nd or/and 3rd magnet on to it so it will have the same measurements of being both set to be pulled/pushed [or pull/push] up and down at the same time on the facing magnet above it [or under it or on the intercepting piece under or above it] in that magnetic field force, but it can be done attached to metal and all the ways understood in the math. This will be for the purpose of making the energy needed to make this interception in-between the magnet[s] and/or metal very small but yet it will definitely intercept this magnetic field in all the ways obvious set to do so. This will then create inducement or movement when the magnetic force renews again. It is a magnet facing a metal or magnet with a intercepting piece that can be made of 3 pieces connected to something that will move it. The main magnet[s] can also be made the same as the depicted intercepting piece, and then be intercepted with a metal/magnet. View FIG. 3 where you will see a magnet 10 facing a metal or magnet 20 with a intercepting piece 30 that can be made of 3 pieces 40 connected to something that will move it 50.

This intercepting piece how ever may also be made by having a less stronger magnet held in a certain proximity with the top one, that the forces pushing it up or down will be neutralized if it is held in the exact wanted proximity, this however is a disparity.

This same concept can also be used by sandwiching a magnet from both sides with metal/magnet that are firmly connected to each other that the same pull of it upwards will be aided and helped from the top of it to pull/push in the opposite direction thus another counterweight in physics of magnets.

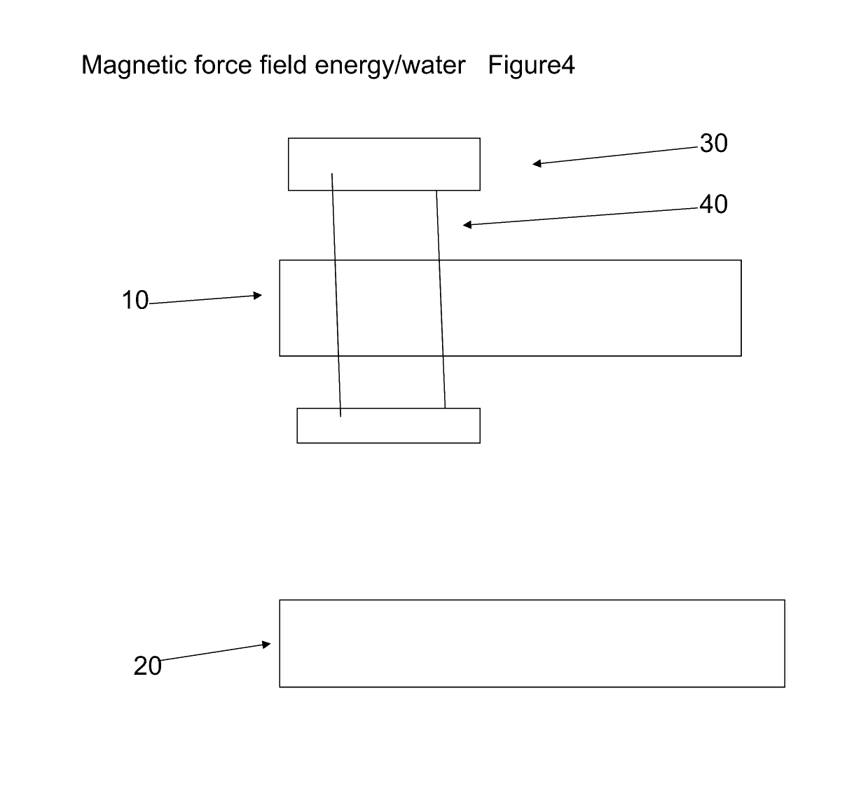

This also will intercept the magnetic field even when using metals that will be of different shapes or attached to different shapes to obscure the magnetic field force from what it was facing. However when using magnets to intercept magnets a force to one way possibly might be made which can be counter-weighted in the obvious ways as seen earlier and later and understood to the people in this field, unless, if wanted in this case it can or it will be made to go around constantly. It is a magnet facing a metal or magnets that are intercepted by 2 (or more) metals or magnets of any shape and size that sandwiches the magnet on both sides and are firmly connected to each other to be and create a counterweight. View FIG. 4 where you will see a magnet 10 facing a metal or magnets 20 that are intercepted by 2 (or more) metals or magnets of any shape and size 30 that sandwiches the magnet 10 on both sides and are firmly connected to each other 40 to be and create a counterweight.

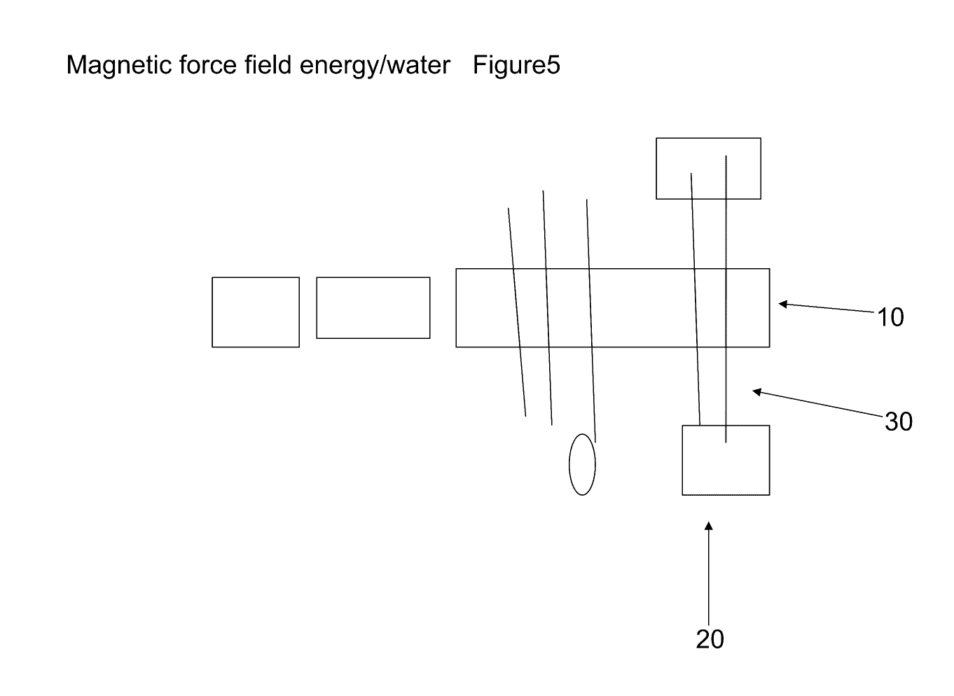

This same concept can be used to generate energy in a generator itself by magnets being situated to sandwich metals that will be separated by metals of a different shapes or kinds so the force doesn't penetrate to each other rather it is intercepted in the middle by those metals, yet it is using almost no energy to move it on top for it is counter-weighted both by it [the inducing magnets] being strongly connected to each other, sandwiching the metals exactly on both sides and also by and from the metals it will always be attracted to, yet it will constantly create energy because the inducement of magnetic force will constantly renew itself as the metals are intercepting themselves and are intercepted with metals of different shapes or kinds to obscure the place the magnetic energy will focus its strength and to intercept it from the next one on its side. This can also be with the magnets moving in-between the metals as there is 2 counterweights 1 the magnets and the metals situation of being held exactly in a certain proximity and the counterweight of the metals themselves so that it is always entering the magnetic field and never leaving it, but the inducement is intercepted with metals of different shapes or kinds. Furthermore in this case of it being counter-weighted and the magnets sandwiching the metals, the metals can be added at fast speed after it was separated from each other, like if it was pushed in one by one by the magnetic force itself that can go backwards and forwards or around and the metals will have a very small space of air in-between the metals. This would be a good way. But also very similar is if the metals are going around like on a wheel always exactly in-between the magnets falling in-between the magnets at the exact place after separation and where they the metals separated, all this would work to induce them with energy of electricity and allow the magnets or metals to move father with very little energy because it is counter-weighted to move on by the next piece of metal, how ever this case [of a wheel going around] has attributes. It has a few metals in-between 2 magnets which/that are connected firmly that go back and forth counterweight-ed to induce the metals with energy. View FIG. 5 where you see a few metals 10 in-between 2 magnets 20 which/that are connected firmly 30 that go back and forth counterweight-ed to induce the metals with energy.

In all cases ever presented a/the metal can be a magnet and/or the magnet can be a metal, it is the same thing in always, and also the words metal/magnets means a metal or a magnet.

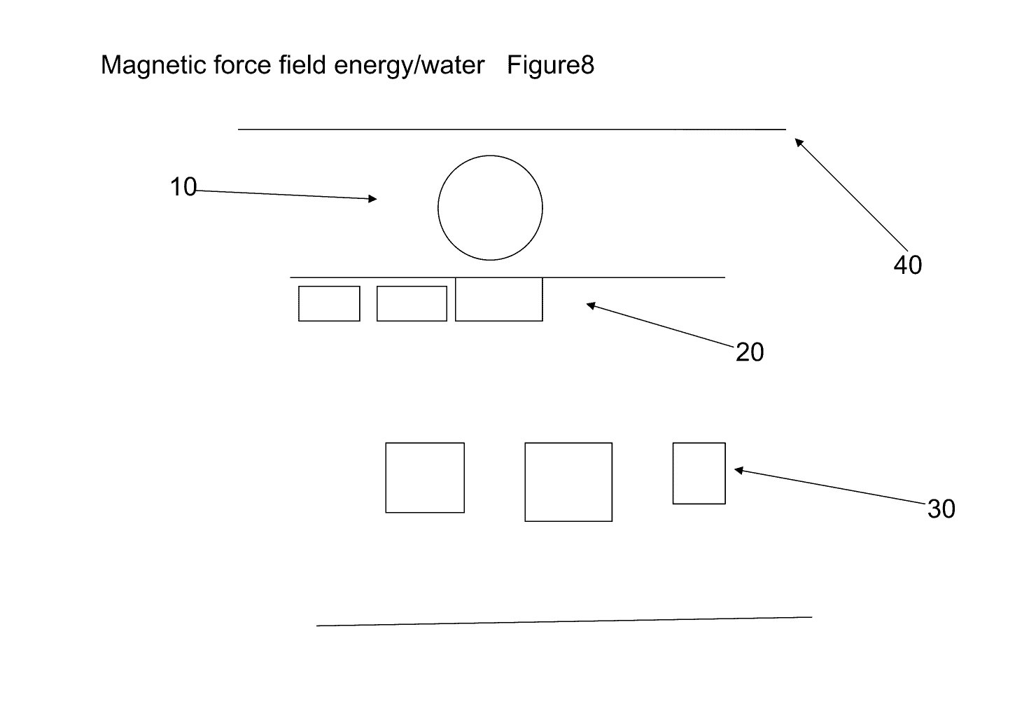

This magnetic field to energy mechanism can also be done with a round magnet or a magnet that is rolled in on/by wheels on one side or on both sides to make also a counterweight of it always attracting the same force, meaning the metals, to make energy constantly and this can be even better because it could/can be made in a way that there will be a small interception in-between the pieces also, and it will still be counterweight-ed the whole time. However wherein it is not going fast enough to create energy or it is not a counterweight twice then it can be rolling on metal on the top or/and bottom and the metal pieces being induce with electricity will be situated exactly in-between. To further the speed and lessen the energy needed, it will roll on a magnet that's force will go higher from the lower, so the rolling magnet will go by itself with speed and to further help it's pull out from the strongest magnet it can or will be attached to others doing the same thing. This might be able to make it battery-less or less. The fastness of a magnet can generate energy on another and to another magnet or metal. The discussion for this will be presented later in the patent where it will be fully understood in-order to make it easier on both of us. It has a round magnet and a metal on top and the induce metals in-between. The figure for this will be presented later in FIG. 8 where it will be fully understood in-order to make it easier on both of us. View FIG. 8 where you see a round magnet 10 and a metal on top 40 and the induce metals in-between 20.

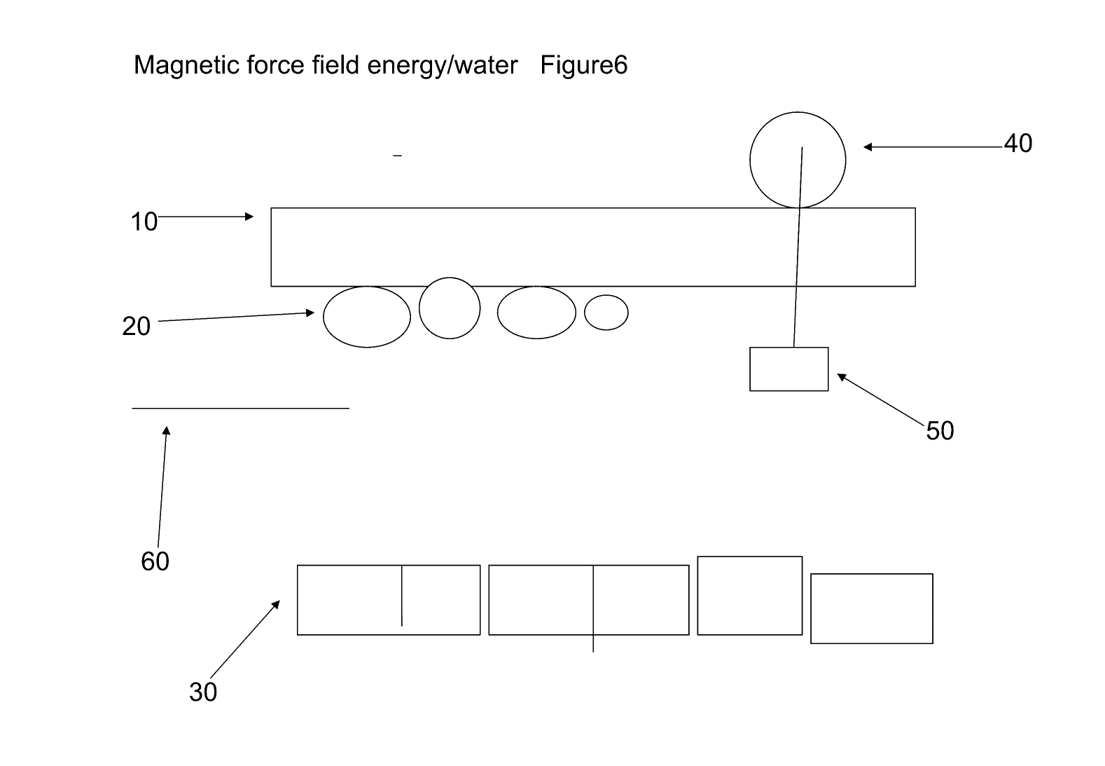

This magnetic force field energy/water device can also be done and made by what is known in another law of magnetism that a piece of steal that is of a shape can be made to obscure the magnetic field to make the magnetic force not facing the metal/magnet underneath it or to spread the magnetic force enough to intercept its hold on what it was facing. This piece of any kind of metal even steal or iron can if wanted be made round to be rolled in that if wanted will be attached to shapes that can obscure the magnetic force or/and it can be on wheels [which is itself a shape that can obscure the force] (including also on any kind of tires) so it will not need a lot of energy to do it, this/the interception in-between the main magnet and the [smaller] magnets or metals it was facing because each push away is aided by the opposite such as a counterweight. It has a magnet and intercepting metals and the metal things it is facing. View FIG. 6 where you see a magnet 10 and intercepting metals 20 and the metal things it is facing 30.

This will help even more when it is in between two magnets as it will constantly create movement back and forth when the opposing forces meet and are then intercepted with very little energy needed as we will see later in this patent. Of course as in all math of this subject it can be done in all the ways and with being attached to any gravity making pieces. These last two sentences are included in the next few sentences yet also separated [not to confuse any one].

This intercepting and also any kind of a shape of metal/magnet piece can also be held under the same magnetic force and pressure at all times so it will take less energy to move it back and forth and it even can be connected to air tires or any kind of tires moving it on the top, including to a counterweight of the stable pressure. Also a part of a magnet being held constantly under the same pressure is the case of point pressure where pressure on a point will be applied either from the top or from the side. And in all cases the energy needed to intercept will be smaller then created, All the more so if the magnet/metal is held in mid air not directly on the magnet as the other one in the paragraph before this that goes preferably directly on the magnets surface in that case, yet it doesn't always have to be, especially if in-between two magnets.

It has wheels and a intercepting piece held under the same magnetic force in mid air. View FIG. 6 where you see wheels 40 and a intercepting piece 50 held under the same magnetic force in mid air.

In all the cases in this patent most of the time the magnets will be held in mid air by a piece protruding in the middle of its way, to hold it in mid air, but since it can be done in any number of obvious ways like with a chain or a string or with magnets opposing it or other ways and also being that it is not always necessary and many times it is not necessary and that when as described earlier, where it can have any gravity making attached pieces such as springs etc. . . . are all seen and understood as part of the mechanism, it is not necessary I felt to have to expand on this simple tiny point to much. It has a protruding piece to hold the magnet in mid air when ever it will be wanted or necessary. View FIG. 6 where you see a protruding piece 60 to hold the magnet in mid air when ever it will be wanted or necessary.

Also the magnetic force field energy/water device as part of this patent is based on what I believe is a fact in magnetism, is that a magnet will only move towards what it is closes to, to what is closes in its proximity it doesn't care and is not aroused in how much metal or iron is on either side or how thick it is as long as it is thick enough for it force.

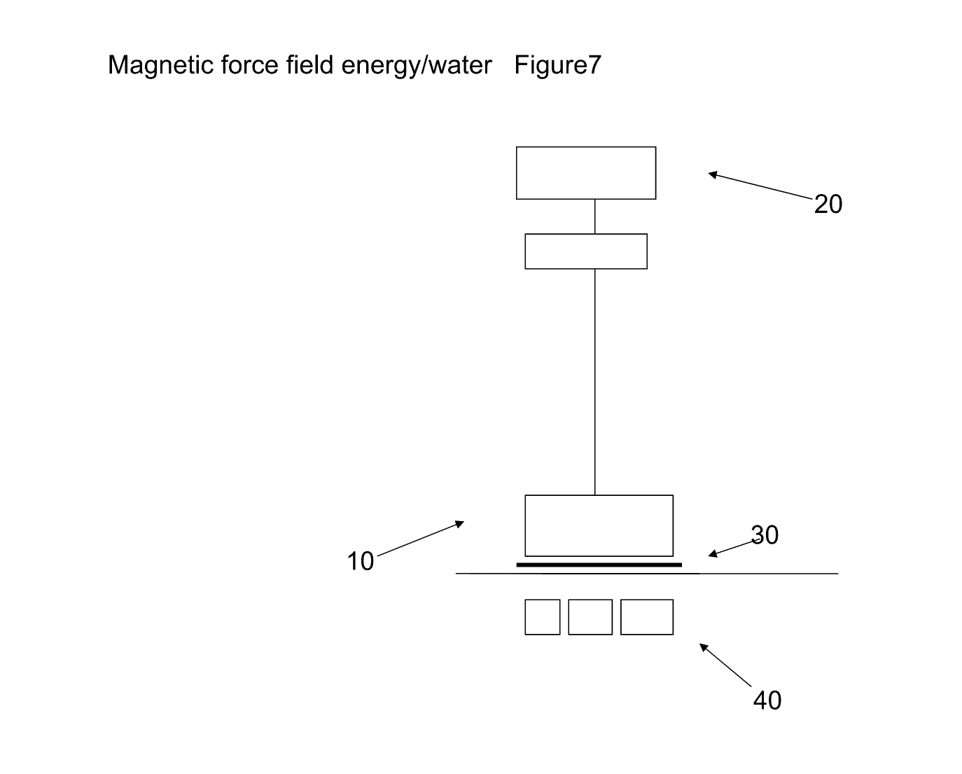

So if we would create a normal counterweight with/in the laws and field of magnetism with no equilibrium and have the/a magnet go from metal/magnet to metal/magnet back and forth like a normal counterweight that exist in many places of our day, [but it can also be counterweight-ed by going around inside a circle attached to the other magnet or magnets,] then the metal or metals on the other side of the rightfully shaped sized slim piece of iron or any kind of metal[s], or maybe even magnet will constantly get movement or inducement and it will cost the same energy as only a counterweight regardless of how much metal is on the other side of that slim piece of iron/metal or even magnet. This however with a little knowledge in physics and its math, can still be done even with out a stable piece of iron or metal/magnet facing the magnets. It has a magnet attached to a counterweight of its gravity force going towards a slim iron piece with the metals on the other side of it. [The piece or pieces on the other side can also be magnet if you really know your magnetic math well and all of its laws as we will learn on in this patent, but being that most of the time magnet or metal is the same thing I do not have to write on this]. View FIG. 7 where you see a magnet 10 attached to a counterweight of its gravity force 20 going towards a slim iron piece 30 with the metals on the other side of it 40.

[In order not to confuse the reader this next case is very similar to one that was presented earlier just one aspect of “the metals on the other side of what it's rolling on” was added.]

This paragraph just above is also the same concept of having a magnet that can roll because it is round but it can also be a magnet rolled in on wheels etc. . . . . On a piece of any kind of metal or maybe even magnet that will be preferably slim that will also be a counterweight because that is what it is, it is counter-weighted to push forward in the math of magnetism so that it doesn't cost the same energy, and it also in the same way doesn't care how much metal is on the other side of the intercepting piece it is rolling on. And this can be a generator itself by either this same thing of the magnet (or metal) rolling fast enough on or over the magnet/metal pieces, or by it rolling on many pieces that will be induced from the force, or that even though they are in line and close to each other they are of a shape [or separated by shapes] that spreads the magnetic force like a rectangle or other so that there is a shock created in the inducement of electric (as explained earlier). However the last thing of this last sentence, will also make [the] metals on the other side get the full magnetic force with out the force being spread from/by the metal the magnet was rolling on. This however can also be made attached to or inside a moving generator in a/the case when it is not one itself, because it will create movement of the metals on the other side of the metals/magnet it was rolling on. It has a magnet and the intercepting [rectangular] piece[s] it is rolling on and the metals on the other side.

View FIG. 8 where you will see a magnet 10 and the intercepting [rectangular] piece[s] it is rolling on 20 and the metals on the other side 30.

Another way to intercept and reunite a magnetic field is via understanding the language of counterweight in the math of a magnetic field, and is based on a fact that part of understanding magnetism is to know that it works mathematically, this is understood to every one that knows any thing about the field of magnetism, that is that its gravity and energy and act is all mathematical. Based on this if we take two opposing magnets that push away from each other and then we put in-between a piece of metal. What happens is the magnets or magnet will make a calculation of the exact place and time to jump up depending on how much exact metal was pushed in, and the same thing is that it will fall and push away from each other with a minor push out of that intercepting piece of metal. This will work understanding the amount of energy it takes to move a generator doesn't really hold the magnets up or down for very long even if it takes another push out or in of that intercepting metal the gravitational math that it makes could be in hundreds of pounds, for example in this case the energy it takes for the magnets to lift a gravitational ton is based on math so much so that a tiny push of the intercepting metal can make the entire difference of that lift and fall because it is always done mathematically, so even though it is possible that it will also be connected in some way to any kind or way of a generator [or to pumping/sifting or to heating water] that small amount of energy that it takes to make movement and conduct the generator will cost a non-important amount of energy when compared to the energy or water it will create from that hole entire ton of gravitational energy.

This intercepting piece could also be held under the same magnetic force on top of it and not leave it so it doesn't cost energy to push out and it could also be intercepting 3 magnets on the bottom that are aligned with each other or it can even be connected to a counterweight of itself [including if it is held with 2 or more round magnets etc. . . . . In order] to further lessen the energy it takes to make that interception. Also understand that in all the cases ever presented if necessary the generator will kick in to connect the generator, only in one of the ways that the magnet goes, in/with all the ways that you can tell a machine to do that command either by any kind or way of a button, video, timer etc. . . . .

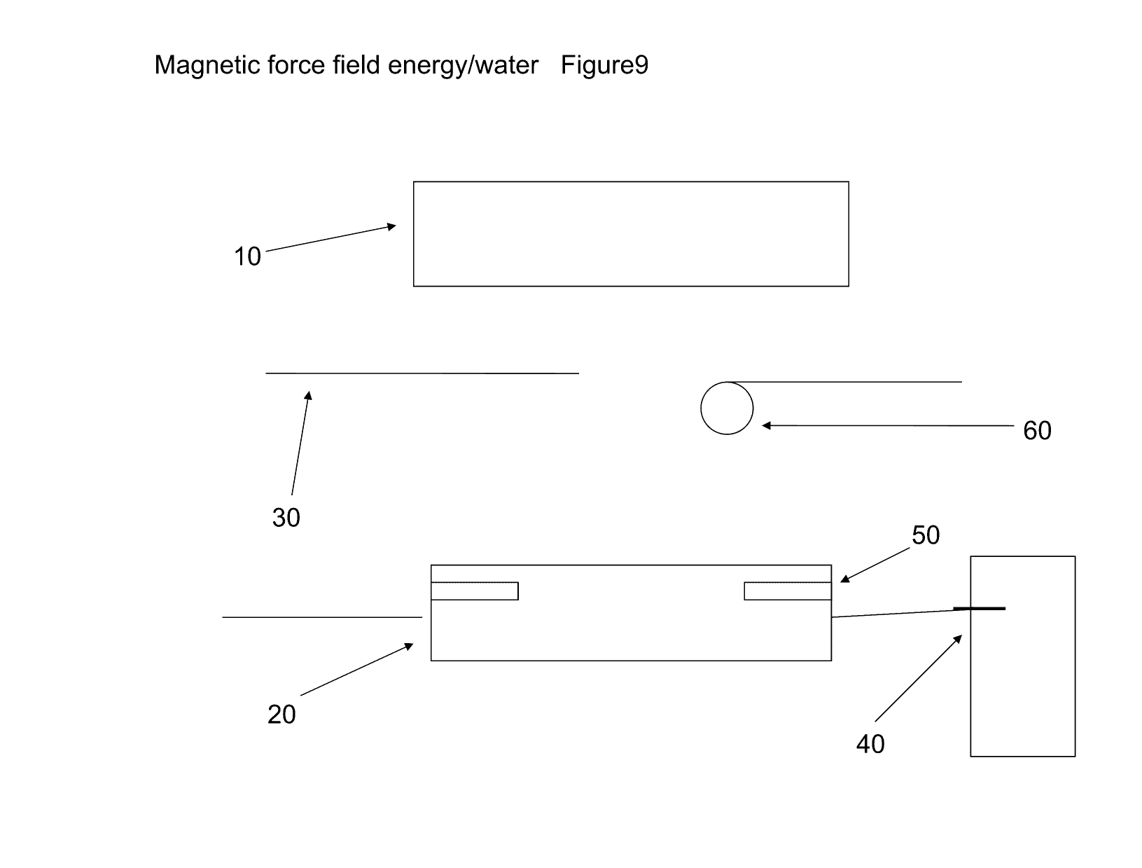

It has a magnet facing and pushing a magnet and a/the intercepting metal and the generator that the ends of the magnet is inside of or attached to. View FIG. 9 where you will see a magnet 10 facing and pushing a magnet 20 and a/the intercepting metal 30 and the generator that the ends of the magnet is inside of or attached to 40.

Also understand as in all the cases presented, that this is only one example of a way to make it, it can also be made when or if jolting to movement round magnets or magnets that are placed on (1 or) 2 or more opposing (magnetic force) wheels. This will create energy as the intercepting piece will also be counter weighted and also use a minute amount of battery power. It can also be made with having the intercepting metals stay stable and be held in-between the magnetic field and go up and down (that can also be connected to counterweight each other with half going up and half down) at the times and places and amounts needed.

A very small disparity of this last case discussed is if the intercepting piece enters the field side ways, facing either two or three, four or more magnets on all sides.

Still explaining the main earlier case, it can be made in all the ways of the math of magnetic fields as in all cases presented, that it can be in all cases magnet or metal and with any way of gravitational pull, but also as in all the cases of magnetic fields presented it can be done in all the ways of magnetism and gravity (including non opposing magnets), especially with the way of using its own weight itself or weights that are part of it in magnetic fields as understood to all the people that know the math of magnetic fields. In all cases of the fields it can be on top or bottom or sideways. In this same case above, one side (the bottom) can be metal/magnet and with the/a piece of metal/magnet intercepting (on top) that will be attached to any (kind of a) counterweight as seen later in the patent. Very similar to this case and part of it, is that it doesn't always need a (opposing) magnet to push it on the top, but it can be done with a magnet that is heavy with gravity (weight or pieces) facing a metal/magnet that goes (on wheels) or rolls in and out or sideways, but if wanted in this case there is air or non metallic substances on the top of it [the bottom main moving magnet]. This in itself will make energy to people that understand, with out having to fool the magnetic field, as it is known that it, a magnetic field can lift one pound with the same math and movement and energy of intercepting and attracting the magnet as it takes it to lift a ton, but if you are steadfast in not believing this new energy, then read the next few sentences, that although is/are not needed they are still convincing. However since the magnet gained in proximity to the metal to lift itself, that metal (will have to) can roll on to a part of that magnet, that can fool the field force using the amount of energy as a counterweight. This would be, if it rolls onto a corner on the side of it or a corner made in-between it, meaning the magnet that jumps up, but even better is, if it can roll onto a part of magnet that is slimmer attached to (the sides of or middle of) it, that can be also of the opposite force or of the same force just [a] slimmer [magnet], so that when that metal that caused the magnetic weight to be lifted, rolls on to the slimmer magnet the heavy weight object of gravity will fall. This way of fooling a magnet can also be done by rolling a metal/magnet that is round like a wheel, on the metal/magnet until the amount of metal/magnet facing the metal/magnet is lessened, till the metal/magnet will fall, all done by counterweight-ed energy of rolling the metal. It has a slimmer piece on the magnet and the rolling metals on the magnet and a round metal wheel. View again FIG. 9 where you see a slimmer piece 50 on the magnet 20 and the rolling metals 30 on the magnet 20 and a round metal wheel 60. This can also be done by it, the attracting metal/magnet rolling on to a magnet next to it also, or on to metal, and any way of direction or side is included in this. A small disparity of this last case discussed [in this very paragraph a few sentences before] is in a case of a seesaw effect, that the metal/magnet will be fooled by the seesaw metal/magnet, tilting towards it till it falls.

All of these prior cases and all the earlier cases of magnetic fields can be understood as a counterweight understanding the math of magnetic force, that the same force helping it up is being aided by that force down or the same force forward is the same as backward.

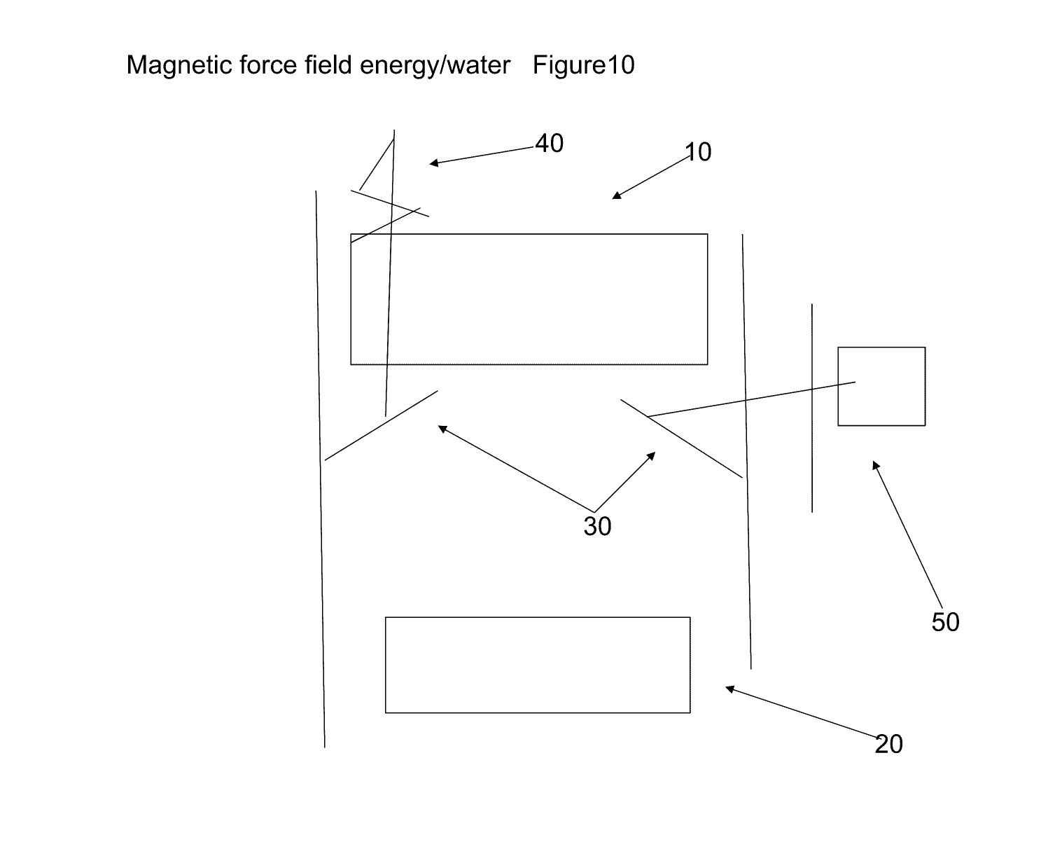

All of these magnetic fields explained can be understood with this one, made to simplify it as a simple counterweight in magnetism, where a slimmer magnet is able to intercept a thicker one using any kind of gravitational force, the same force as the magnet its intercepting to go off and on of the force field to intercept it, for it to reunite its position and force. This will most of the time be also with smaller magnets connected together or working together at the same time. This can be understood with the simple counterweight using the main magnets energy to help it intercept the field from what it was facing and then going back using the counterweight. It has a magnet that is facing a metal or magnet and a intercepting slimmer and smaller pieced metal or magnets connected and attached to a counter-weighing gravitational pull that can be a spring or a magnet or anything that can give that gravitational pull similar to a magnet or spring. View FIG. 10 where you see a magnet 10 that is facing a metal or magnet 20 and a intercepting slimmer and smaller pieced metal or magnets 30 connected and attached to a counter-weighing gravitational pull that can be a spring 40 or a magnet 50 or anything that can give that gravitational pull similar to a magnet or spring.

This also can be added and attached to the earlier one this last case, and to all earlier ones (meaning cases) when needed and also to this latter one that was discussed before when there are weights or gravity pieces pushing the magnets apart, then this counterweight now discussed could be added to a portion and percentage of that main larger magnate facing the magnetic field with a/the piece of iron or metal to attract the magnet as discussed earlier or even without it, that iron/metal piece, to further prove that the interception of magnetic force can be done for a much minute power then it, the magnetic field will create with the full force of the magnet. This however I believe was explained or understood earlier any way when discussing that case.

Also in all cases in this patent it can be any kind of metal or magnet and from any direction or side and it can go around on a wheel or wheels and it can be with opposing or non opposing magnets.

But it should be understood that being I believe I am the first to introduce energy from magnetic fields as working, then all the cases being presented should work together, and where and if all of the cases are put together, meaning putting many or some or two of the cases presented together, they shall all be understood as part of the teachings of this patent and they still shall all be understood as a counterweight in the force field of magnetic physics. This is all one patent.

Also part of the magnetic field force energy/water device is by the way of using a trigger that the force of the magnet will pull any kind of a trigger to trigger with a trigger a bang against it [the magnet], when it hits the top to fall around and back again under the main magnet creating all the time greater energy then needed using the magnets staying power. I did not want to leave out this case of a magnet puling a trigger against itself on the way up towards the magnet in order to use that same force to push it away and/or to intercept the field with a intercepting piece, for the metal/magnet to then, fall around and/or back again into the magnetic field from maybe or maybe not a lower extended place and it may need some extra energy like the same amount as a counterweight to make the extra bang out or may not need even any energy at all to intercept that field depending on the case of what kind of trigger or metal/magnet.

This case although it being a right one that will work, but being that I feel it is/was rightfully taught and explained in all the cases already presented I felt that I not have to expand on it to much. Even though you may be able to make it on no usage of energy what so ever if you get a good enough trigger and/or earlier discussed intercepting pieces etc. Meaning it may not even need a battery. A small disparity of this case is if we make a magnetic ball that only one of the magnetic polls are facing out and the other is facing in, and then we use magnets to push and/or pull the ball in all ways around or down etc. . . . [held in a encasing, and] this still will create energy from the interception of that magnet on place with a magnet or its bigger (magnetic pull or) push. Yet no trigger is necessarily needed in this case. In this case however it may be able to be held in mid air and then make energy from gravity [by it lifting gravity things or from movement etc. . . . ].

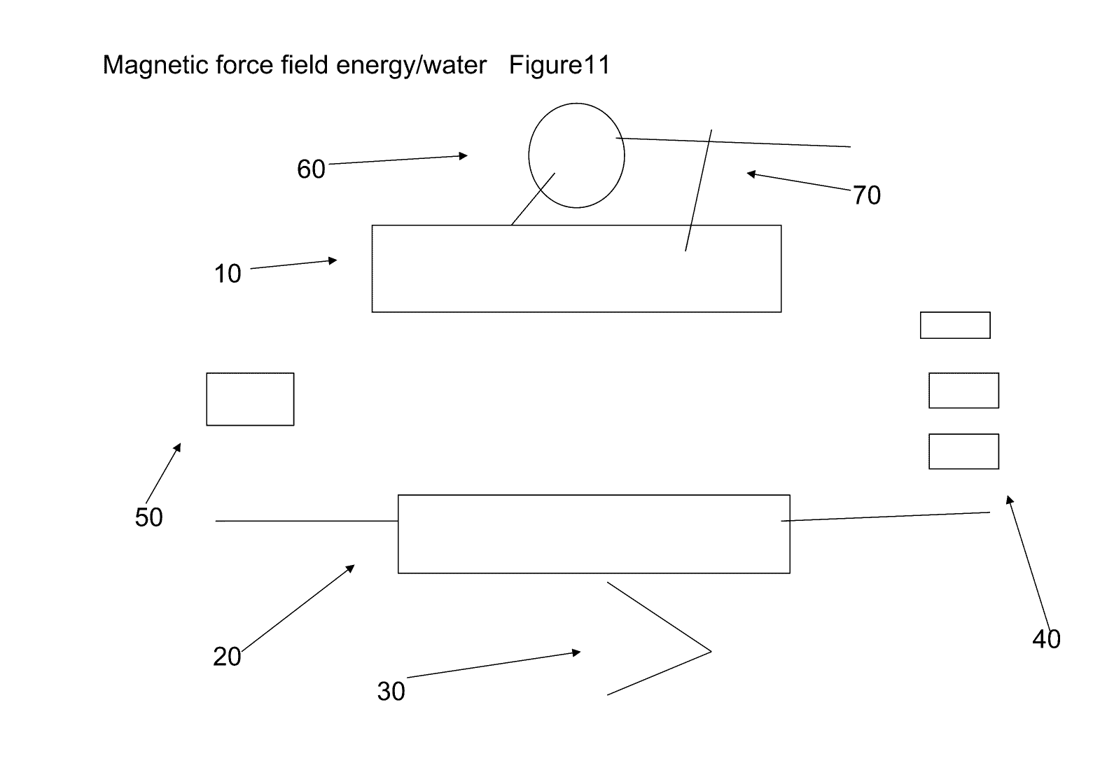

This interception of a magnetic field can also be done by and with electricity; this will bring us back to the first case of a magnet lifting gravity force according to its exact strength. Here is a quick re-run of it. The mechanism has a magnet that can/will also be intercepted by way of counterweight. This will intercept the magnetic force from the facing metal/magnet it is maneuvering. This counterweight can be with a spring, weights set to get more and heavier with closer proximity, magnets, elastic, air or water pressure or any thing known in the field of physics to have a push and pull force [this includes anything that will be known in the future]. In this case how ever when the electricity goes on and off the electro magnet in all the ways and every way known [or that will be known in the future] to cost the least energy, for example by the way of making higher and lowering a volume in order for it not to cost more energy from the voltage, from it jumping on, or by the electric wire(s) going fast on and off the electro magnet fast enough to lift the facing object yet so it can use a lower voltage then needed or by using more then one wire (by going around with it in a circle or not) to go on and off the electro magnet so it can stay a low voltage, and still be as effective from the jump of voltage. All of this is done In order that when this happens and the electricity goes on and off the electro magnet the magnetic field s force will be Intercepted from the facing metal/magnets causing movement from gravity. This movement will be connected to or inside of the generator to make energy. It has a electro magnet facing a metal/magnet and a springs, or weights set to get higher with closer proximity or opposing magnets and a wire on top going on and off either by volume or movement. View FIG. 11 where you will see [it has] a electro magnet 10 facing a metal/magnet 20 and a springs 30, or weights set to get higher with closer proximity 40 or opposing magnets 50 and a wire on top going on and off either by volume 60 or movement 70.

The interception of the magnetic field can also be done via electricity intercepting it with electricity or any thing that can carry electricity or even project electricity and this still doesn't exclude something that can hold stable electricity, but most simply by a piece of metal that can or will also be set to have only one of the electricity voltages of either electric protons or the electric neutrons meaning electrons, that can intercept the magnetic field for less energy, because if the voltages are not connected then it doesn't burn energy, but it will still intercept the magnetic field. This if being true can also be a generator by it, the electric current going on and off the intercepting piece. But it might need a small piece of rubber or anything known to not be penetrable by electricity and to coat electricity in-between it, meaning the metal that will hold one of the force currents of electricity and the generators metal so the electricity doesn't go through to cost it energy, but the generators metal will be induced when the intercepting pieces electricity will be turned off or when it will be moved away from the field inducing energy. If the/that metal will be moved in and out it will not need the piece of rubber etc. . . . that was just discussed, to make sure no energy burns. It may need that rubber or holding, insulating electric material in-between it and the main magnet however.

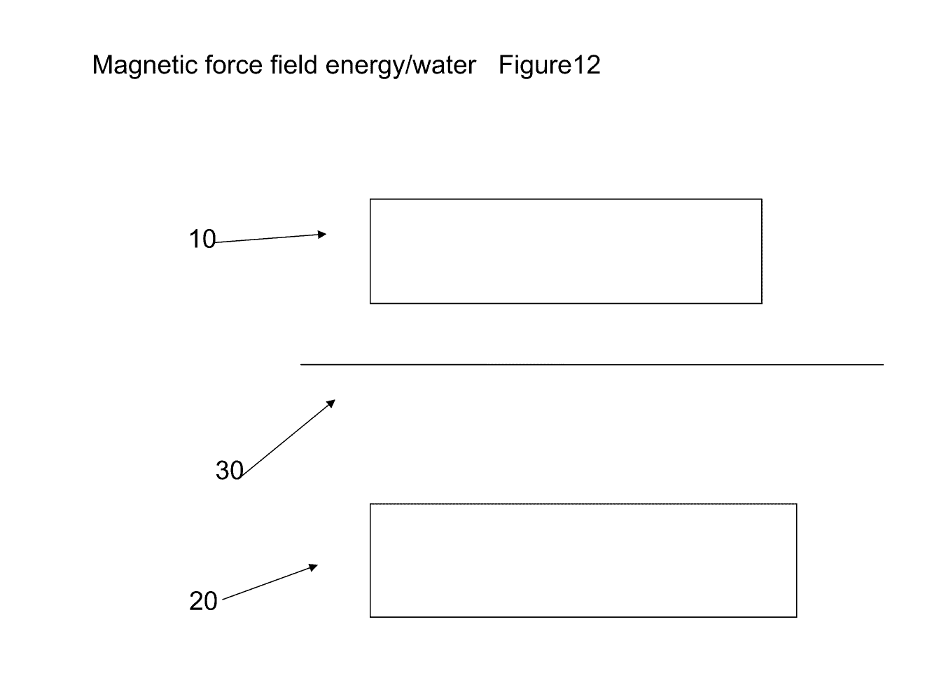

This same concept and thing can still also be part of a electric generator and also turn around in/with the magnetic field of a electric generator, together, and/or also if needed (the)[/a rubber piece discussed or a Yd wire in the middle can be a part of this but to express it shortly 1, 2, or 3 or more] wires carrying the electric in all ways will go on and off, that can be timed if needed or even not. All this is In order to help the metal/magnet push out of the magnets inducing in a generator and etc. . . . . But this as others, being not the main case shall not confuse us from the more important depicted cases. It has a magnet facing a metal/magnet and a intercepting piece that will carry the electric current. View FIG. 12 where you see a magnet 10 facing a metal/magnet 20 and a intercepting piece 30 that will carry the electric current.

As in I think in almost all the cases presented when we are not rubbing chemicals to heat up water or using another method of creating electricity like from rubbing silk and glass, but when we are using magnetism to make energy, then those very magnets or metals themselves can by themselves be the ones induced with electricity to make energy, in almost every case including the next one that can both make and create movement of metal for the movement of a generator or be a generator by itself, although in this case of electricity it may or may not be true in all the cases of physics with out necessarily electro magnets I think it is.

In all cases presented in this patent those very metal/magnets induced can be an electric generator itself with out the need of it being attached to or inside of a electric generator.

The interception of the magnetic field can also be done by facing two magnets of the same strength, but the opposite strength of the opposing poles that oppose each other to go against each others forces that can if needed be separated by air or by a slim/small piece of rubber and anything known not to be penetrable by electricity. The electro magnet can be either the one facing the top main magnet that will be moving the metal/magnets and thus intercepting it or the electro magnet can be the top main magnet itself penetrating that interception. The intercepting magnet as in all cases will preferably be slimmer then the one on top but if it is of the same strength it will still intercept its force.

This will create energy understanding a law of magnetism. That if 2 magnets are strongest they can be, and they are facing each other to oppose each other, when electric force is added to one of them that one will pierce through the force of the one under it according to its proximity and thickness and once it pierces through it, it will be full force not less. But that electricity can also be entered in to the bottom slimmer intercepting magnet as well. So by using a small amount of energy added the main large magnet can pierce through full force on the things it was being intercepted from.

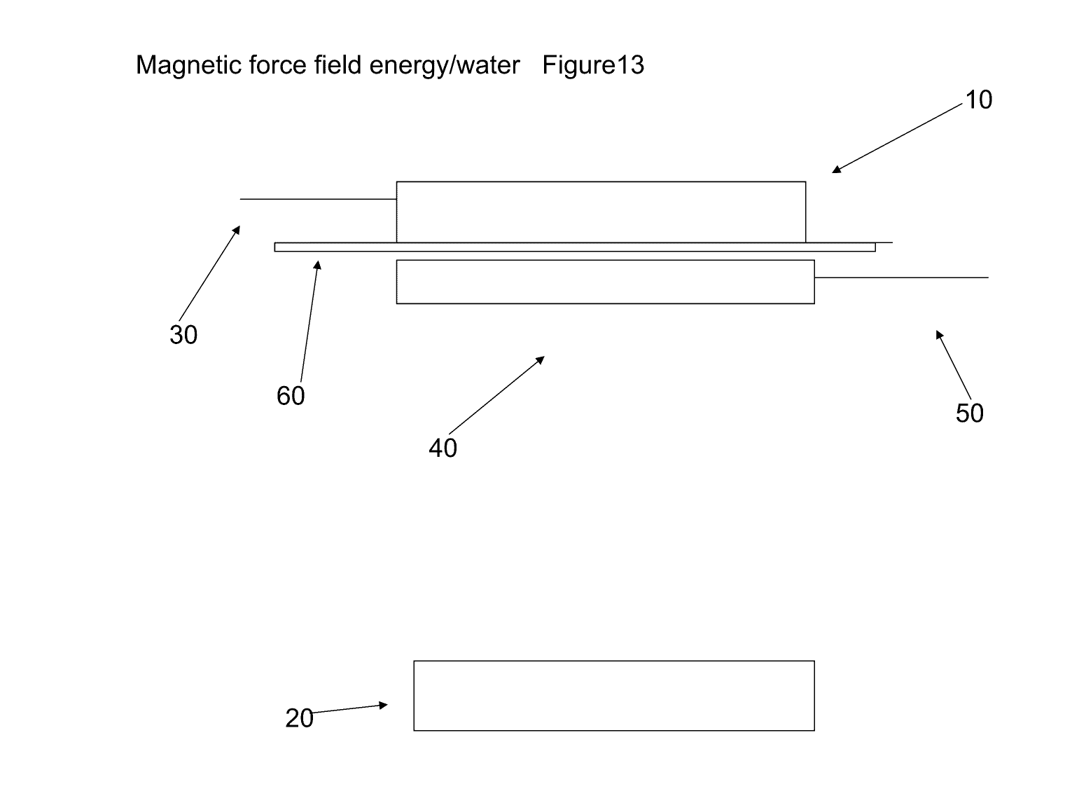

But also it can be done if the one under it is of less energy and it was already pierced by the magnet on top of it and then the electricity added can fill the gap to add to its power to intercept it, the other stronger manipulating magnet from the facing metal/magnets. This can be done also using only one of the electric powers of neutron or proton like explained and illustrated before. This also will not make the lower intercepting piece in the case that it is a magnet of less energy, into a strong[er] magnet itself, because the electric flow will be to constantly go on and out of it (or around). Especially or particularly in this prior case of it intercepting the magnet by/with small electricity. This could/should mean the same energy as a counterweight, used and meant, for it always uses the magnets energy itself to pierce full force the interception and or to make it. The electro magnet pierces the lower magnets force full force. It has a magnet facing a metal or magnet with a electric wire and the intercepting piece with a electric wire and a piece of rubber in-between. View FIG. 13 where you see a magnet 10 facing a metal or magnet 20 with a electric wire 30 and the intercepting piece 40 with a electric wire 50 and a piece of rubber in-between 60.

Yet I'm not sure if it, in all cases needs to be facing a/the metal/magnet.

All of the above shall be considered part of physics including this one which is if magnets are ground up or if there are things and substances that are found to hold electricity in it, it would intercept the field of the magnet for it, the magnet it will not penetrate. Also is if the intercepting poll force magnet or magnets is/are very slim or thin, this also will intercept it, the magnetic field force with less energy use. This should still be considered part of physics. This is based partly on a law of magnetism that magnetic force doesn't have a power on very small or slim/thin metal things.

There also maybe In ways of chemistry, in literature found from the 17th century period many things are believed to intercept or obscure the force of a magnetic field like diamond, sapphire vinegar, fats, oils, hot water, garlic etc. . . . none of them however where yet attached to a battery making energy. And although the chances of it/them working now a days are very slim there may be things believed in public literature to intercept magnetic fields, [like plastic magnets, certain acids, lead or leather, or the [new] elements etc. . . . ] that can still be patented as nobody put it together with a battery yet so far. And I know this to be true because of the every day facts of life I live in. It has a magnet/metal facing a magnet/metal and the/a interceptor. View FIG. 12 where you see 10 a magnet/metal facing a magnet/metal 20 and the interceptore 30.

Very important, and not to be forgotten, is when two or more of the cases depicted are used in conjunction, it shall all be considered part of the patent. This will help me also as it is only one patent. But in case, two or more of the cases depicted or discussed or written about are used in one conjunction it shall all be a part of this patent. Obviously such cases will help even more in the science of creating energy from magnetic fields.

All the teachings of this patent shall be held as part of the originality of the patent even if one is to come and say that he found one that differs in some extent, with the originality of this new patent, being that it was in the want and hard work of the originator, that not only knew it as a law of patenting but saw the cases as endless and never ending in explanation. The inventor has seen many languages in all the patents how the lawyers and inventors always express, that the broader scope of the patent being patented is not confined to these lines only, rather that the broader scope and teachings of the patent shall remain as part of the patent. All of those languages and ways of saying It, are all written so eloquently and strong and beautiful that the inventor just doesn't know which one to choose or pick, therefore he asked that all of those forms/manners and ways of saying that the broader scope of the invention and the spirit or teachings of the invention are still included in the patent, be considered as if they where written here in true actuality.

This new energy and water made from it is new to the world of any man living today.

This is a magnetic field that will be intercepted using a much less energy then it would usually need based on all ways of counterweight and use of electrical force, in order to generate energy and make a stronger inducement or movement of any kind or way of a electric generator or chemicals or substances that make heat that will also be able to heat up water for fields and drink etc. In all cases it is a magnetic field with magnets and metals that's force can be intercepted from what it is facing using all the ways of counterweight that there is in the math of magnets and metals either from having a gravitational pull made on the magnets from spring, magnets or other, or from the intercepting pieces being made to be all counterweight-ed that the same pull in or up will always be the same of it out or down, or in the use of a magnets math to cleave and run from each other and also through ways of electric force that can shift, pierce or intercept the magnetic field, it may also be able to be done in ways of chemistry. In all cases more and greater energy will always be produced when the magnetic force field re-unites to re-play the act again and again. This specification is the same as the other, with out the figure, and no new matter in this specification.

What is claimed is:

1: a mechanism to produce portable and clean energy and battery and electrical power and even to clean/heat up water (from movement) for land, comprising: a magnet of any kind; that will be in a magnetic field facing a metal or magnet; and a intercepting metal or magnet of any kind that will intercept the magnetic field using less energy and power then the field will create when the magnetic field force re-positions themselves again, because these interceptions will be in all the ways of counter-weighting the magnetic fields force, mostly by a slimmer piece set to be counter-weighted while intercepting the magnetic field force, of which the best case will further comprise; a simple slim magnet that will be [situated to be] of the opposing force [in the magnetic field]; that will be attached to a magnet or (two, side) magnets that will be [situated to be] of the attracting force [in the magnetic field]; wherein the movement of this intercepting piece will intercept the magnetic field (with very little energy as the force it usually would take to intercept with a opposing magnet the magnetic field is counter-weighted by the other half of the magnetic piece) wherein the interceptions and renewals of the magnetic force on the metal/magnet it was facing will create the movement of the/that metal, as the metal will move, either from its own gravity [or magnetic force] or from [it (further) comprising and] being attached to all things known to have a gravitational pull/push (including springs, opposing magnets, elastic, or air/water pressure), wherein it [this movement created] can be in-between or connected to any kind or way of a generator but the metals or magnets in the magnetic field getting induced from the same interceptions and re-positioning of the magnetic force can also be a generator in itself as well, and this mechanism will also work with/in vehicle movement or by itself, when done with manpower alone, or with a added rechargeable or nonchargeable battery and even with gas, solar or wind energy, and in all (the) cases (of) the magnetic fields and the interceptions, (it) includes the use of electro magnetism.

2: The magnetic force field energy/water device as part of claim 1, wherein it comprises; a metal/magnet in a magnetic field, facing a metal or magnet; and all things that make a gravitational pull or push that can be connected to the metal/magnet(s) [facing each other] in the magnetic field to make this counterweight that will intercept the magnetic force, this can be springs of any kind, magnets themselves that are opposing each other, weights set to be carried with closer proximity to top magnet or to be placed on the metals, elastic, air or water pressure or anything known to make that gravitational pull/push wherein this will further comprise; something that will push the (facing) magnets apart, so that only one small push that is possible also with a counterweight, and/or wheels on either of the (two) metal/magnets [that are facing each other] in the magnetic field in either way or direction will separate that force of what carried prior to interception gravitational power that can move a generator that is set to go on and off of the moving metals or magnets if needed, or pump or sift or heat up water, (from movement, rubbing, or other) and this way of using the gravity of a magnetic field to make energy from movement, includes all the things that make energy from movement created from the interceptions and re-positioning of the magnetic field, that only a small push will separate the force and then vise versa.

3: The magnetic force field energy/water device as part of claim 1, wherein the intercepting slimmer (magnetic) piece [or main magnet[s] of this magnetic field will be made (or set) in the magnetic force of the piece or [attached] pieces to be separated (in it's magnetic force) into two, three or more parts [with the differences of North and South Pole,] in order to have the same magnetic force of it, this one intercepting piece, pushing it up/forth the same as it is being pushed down/back all in one piece, that the same force it was made to push away from the facing magnet will be counter-weighted exactly with magnetic force to push the opposite way or towards the magnet/metal, this a counterweight that will obviously intercept the magnetic field in any way wanted, and many ways, such as if the intercepting piece is larger then the metals/magnets being maneuvered or induced by the main magnet, yet this is only one example, but this intercepting magnet understandably can also be attached to metal and all of it can be done in all the ways understood in the math, including using two of these intercepting magnets attached to each other to do the interception at the same time, as this was my first good classical case.

4: The magnetic force field energy/water device as part of claim 1, wherein it comprises a magnet in a magnetic field that will be sandwiched by metals or magnets on both side's to intercept the force field, always counterweight-ed that the same force of the intercepting piece getting pushed/pulled on the bottom of this magnet that's facing in the magnetic field will be counterweight-ed by this intercepting piece being firmly connected and attached to the other metal or magnet (that can also be intercepting) on the other side of this magnet in the magnetic field (as it's getting pulled and pushed in the opposite direction), this can intercept the field with magnets, which can also be counterweight-ed if there is a push in one direction or it can also just go around in a circle, or when done with metal it can obscure the force of the magnetic field by using metals of different shapes, as is known that metals of different shapes can obscure a magnetic field, but when using magnets to intercept the field a doubled magnetic piece that has only one of the polls facing outwards can also be used.

5: The magnetic force field energy/water device as part of claim 1, wherein the concept of a counterweight in magnetic physics and of sandwiching metals/magnets will also be a new generator, it will comprise, metals that are separated by metals of different shapes or metals that are separated with tiny bit of air, that will go in-between two (or more) magnets, sandwiched exactly in-between, with either the magnets that are inducing the metals or the metals getting induced moving, however it can also be done by the metals [that will be induced, that will be] falling from a wheel in-between exactly in the space between the magnets [that will induce the metals], where and when the/those metals are set to hit each other after separation, so that the inducing power of the magnets to the metal will be completely on and off in order for it to generate electricity.

6: The magnetic force field energy/water device as part of claim 1, wherein it comprises; a magnet in a magnetic field; and a intercepting piece that can be a metal made of a shape that will obscure the magnetic field force that can be rolled in on top of the/this magnet, that is facing metal/magnets in the magnetic field, if it is round wherein it can be a part of or attached to any shape including a wheel or it can be held under the same pressure of that magnet constantly with using any kind of wheels or tires so that it will intercept the magnetic force of the magnet(s) in the magnetic field from the metals or magnets it was facing in the/this magnetic field, this includes when it is intercepting with (non opposing or) opposing force magnets, of which the pressure can if wanted also be counter-weighted so that the force of the opposing magnets doesn't have full gravitational power or stability, but either way it will be held constantly under the magnetic pressure, and this also includes all the cases of putting pressure on a pointy end, called point pressure, from any side either on/from the top or even the side as it is the same thing in physics as being held on wheels that move and are being held under the same constant pressure, but when using magnets to intercept the field a doubled magnetic piece that has only one of the polls facing outwards can also be used, and this will also help it go around in-between or in and out of the magnetic field.

7: The magnetic force field energy/water device as part of claim 1, wherein (being that a magnet is usually not attracted to the thickness of the metal or metals rather only on the proximity of/to them), a very simple counterweight is/be made with metal/magnet, from the main magnets that maneuver or induce the metals or magnets, that are attached to a counterweight being the exact same force of magnetic power in each way, meaning to include with opposing magnets[but this can be with any kind of a counterweight including the case of it being counterweight-ed by going around in a circle], that can go in-between 2 [or more] the same as magnet sized pieces of iron or that one end will be a magnet facing a iron or metal or magnet the same sized piece in width but not thickness, in order that together with this counterweight and that amount of energy used, the metals or metal on the other side of the magnetic force pierced, stable any kind of metal piece, will be moved, maneuvered or induced, this can also be done wherein it is a small piece of a whole of a magnet that will be thus, in this way counter-weighted to drop a big load that was counter-weighted with gravity pieces as seen in claim 2, however it can also be done with out having to face a magnetic force piercing piece and that stable magnetic attracting piece, with the math, however understanding that in all cases it will be connected to any kind or way of a generator that will create energy so will this case create energy in the same way [and when going around in a circle a/the magnetic piece intercepting can actually make it go by itself, edged on both from the speed of the heightening in/of the magnetic force of the magnets and from its connection to the other hand or hands, doing the same thing, and as all cases this includes the use of electro magnetism].

8: The magnetic force field energy/water device as part of claim 1, wherein it comprises, a magnet that is round or is rolled or slides in on wheels, that will go on top a piece or pieces of any kind of metal or magnet, so it is always counterweight-ed by the intercepting piece it is rolling on, and this intercepting piece can be in the middle of the magnetic field for it, the magnet to roll on or this any kind of metal/magnet piece that the magnet will roll on can be on the top and/or on the bottom (or side) of the magnetic field, in order to make energy when inducing the metal and all the metals or magnets that its force comes into contact with be they on the other side of the iron/metal of/on which the main magnet was rolling on, in which the metals can be connected to any way of a generator or those metal/iron or magnets themselves, including as many kinds and amount of metals that it wants to have the magnetic force on, and these metals can also be of a shape to obscure the energy from each other, and when it's rolling on magnets it will actually be able to go by itself by going from north to south pole or vise versa, or from the heightening of magnetic force in the magnets, all the more so if it is attached to others that will help the pull out from the (last and strongest) magnets, this will make it go by itself, if not maybe only a very small and minute battery power, however as in all cases this case includes the use of electro magnetism.

9: The magnetic force field energy/water device as part of claim 1, wherein there is a magnetic field of two same pole magnets that will oppose each other to push away from each other, (for example 2 square magnets or if they are placed on 2 wheels) that will be intercepted by a piece of metal that can go in and out so the magnets will come together on that metal in-between it, at the exact moment that it can and then fall apart again by a small push out from that metal that was intercepting it, which can be a metal that is being held under the constant same force of the magnet or not or it can also be counter-weighted by intercepting or moving into or on to 1, 2 or three smaller magnets on both sides at one time or also it can be attached to a counterweight itself, to lessen the energy it needs to move back and forth, but it can also be done without facing a magnet that pushes it away with the opposing magnetic poll force, [rather] as in a counterweight, either with a counterweight in/of the top magnet/metal piece facing the metal/magnet [meaning the earlier intercepting piece will now be a counterweighted attracting magnet] or a counterweight of gravity with 2 non opposing magnets or with only 1 magnet, as explained, and as understood that the same energy it takes to mathematically move a pound in this magnetic field is the same as it takes to mathematically move a ton, that on both a ton or a pound it mathematically only takes a small movement of the metal/magnet to change the magnetic field, but still it can be done with the intercepting piece entering the field sideways facing any number of metal magnets on any side, however in all cases more energy will be created then that was used to make the shift of the magnetic field when the magnets will move back and forth, and be in-between or connected to any way of a generator or any kind of generators that can go off and on of it when and if needed in all the ways that a generator can know too, either by any kind of button or video or timer, this also maybe done even with stable pieces of metal/magnet going up and down in-between the two magnets, and those same pieces can be connected to each other or not, and also those pieces if needed can be connected to a counterweight [or actually counterweight themselves and each other].

10: The magnetic force field energy/water device as part of claim 1, wherein it comprises, a metal/magnet that's facing a metal/magnet, and the metal/magnet attracts the/this metal/magnet to its close proximity, wherein this attracting metal/magnet will roll onto a slimmer attached magnet [that (only if wanted can also possibly be intercepting and) is a part of, or attached to the attracted magnetic piece] to fool the magnetic field of this magnet that was attracted or first attached itself to lose its grip, this can also be onto a corner, which will include a metal/magnet ball (or piece) that is heavy that will roll on a metal/magnet seesaw [that can be fooled from the thickness and slimness of the seesaw metal magnet], that can either fall from or go around the seesaw corner, this can obviously create energy from gravity and movement even without the corner, however this rolling magnetic/metal poll or wheel can also roll onto a side magnet/metal or none metallic substances in any way or direction or side that is wanted, in order to make energy in the math of magnetic physics, but if on non metallic substances it can also make energy when facing an opposing magnet, and when done with a round metal/magnet moving back and forth, [attached to a metal/magnet] on top of the metal/magnet being maneuvered or induced it will actually fool the magnetic field with using counterweight amount of energy to be intercepted, from the magnetic field by moving out of it, and that will cause that metal/magnet not to be facing the earlier amount of metal/magnet.

11: The magnetic force field energy/water device as part of claim 1, wherein it comprises; a magnet; in a magnetic field facing a metal or magnet; and a slim magnet (that will intercept sideways (or go around), in-between the magnetic field) or slimmer and smaller magnets that (go up and down to) intercept the magnetic field; that will be counter-weighted with all things known to be able to counterweight the gravitational pull, like with any kind of a spring or with magnets themselves, this/that will not have a equilibrium, in order so that the (stable) magnet in this magnetic field that is facing the metal or magnets that will be maneuvered or induced, very own force will help with the interception of itself to intercept it self's force, [these intercepting pieces can also be connected or attached to each other to make a counterweight and/or counterweight each other however] this also will create movement of greater power then used for that interception when the magnetic force re-positions and goes back in the magnetic field it was earlier facing, this is also true inside of a generator itself using things of a gravitational pull or other generators to work in conjunction and counterweight each other, still this same concept can also be done with a trigger [of any kind or spring] that will be pulled with the magnets force to shoot the metal or magnet that can be a magnetic ball that has only one of its poles facing outwards, that was maneuvered and manipulated by the-main one (the facing magnet) away for it to fall back around again, held in the (extendable and/or movable) case it is held in, or to shoot the [explained] intercepting piece in between to intercept it, or to shoot the ball away with the help of a opposing magnet that will be situated on the side of it [however the use of an electro magnet is preferable], this still includes the making of a magnetic ball or wheel that only one of the magnetic polls is facing outwards, to be lifted and/or to lift, or pushed/pulled, or thrown, in any direction, [including around] held in a encasing (from the outside or including from in-between the wheel by the same kind of magnetic force) and/or in-between generators, always intercepted from a magnet, to make energy from gravity, or from lifting gravity, cause the magnetic forces are always counterweighted and are counter weighting gravity, or pushing [via opposing (electro)magnet] or pulling gravity, yet no trigger is exactly or necessarily needed in this case rather only the magnetic force especially when lifting in the encasing things of gravity, but this is still a part of claim 11 as the same way the ball or wheel can be made with only one of the magnetic polls facing outwards so to a piece can be made this way also but this also includes in the other claims that a magnetic ball or wheel or piece can be made with only one of the magnetic poll forces facing outwards, in the cases depicted in this patent.

12: The magnetic force field energy/water device as part of claim 1, wherein electricity in and with a electro magnet will be set to go on and off the electro magnet to help to counterweight and lift with the magnet, or the counterweight of the metal/magnets gravity it was/is facing with electric energy on the top that can be made in a way that there is no jump of voltage that will waste energy like by the electric wire being connected to a volume piece that moves closer to each other for higher/lower voltage or by the wire going on and off of it fast enough to lift the metals it is facing against there gravitational weight which can be done with more then one wire if needed or with any other way that is known to solve the problem of a high voltage jump, including by turning the elec. wire around, in order that the magnets or metals it is facing will jump up and then with gravity fall down with the electro magnets power going off and on or around, and by electro magnet I meant also to include with a regular magnet, that we will add to it or through it electrical force.

13: The magnetic force field energy/water device as part of claim 1, wherein the magnetic field will be intercepted with a electric current of one of the electric currents of either electric proton or neutron so that there will be no burning of electricity but doesn't exclude and can also be with both voltages, in order to obscure the magnetic field force, in which the electric force will be passing through or (possibly via a middle piece) going around (including back into the battery) and this still does not exclude even staying stable, in order that the magnetic field will be intercepted by the voltage of an electric current by any thing that can carry or project electric current most simply [and preferably] however with a kind of a metal, this can obviously also be a generator by itself when the metal or magnet in-between will go off and on from the inducing magnets the same way as the interception will, that can have a tiny piece of rubber or something that electricity does not go through so that the voltages will not connect to each other if wanted or needed, or it can turn around in a generator together with the metal and/or have wires that go on and off that can be timed or not, to help the push out from the inducing magnets, but it can also be something that will intercept the magnetic field from what it was facing to drop the gravitational weight it held or vise versa (when using opposing magnets) and then to carry it once again when the magnetic force re-positions itself in the field as with all the cases in the claims 1-12.

14: The magnetic force field energy/water device as part of claim 1, wherein the slimmer intercepting and opposing piece is of the same force of the facing main magnet that's magnetic force will be pierced full force with only a little bit of electricity as in a electro magnet, and by electro magnet I meant also to include with a regular magnet, that we will add to it or [with wire] through it electric force, so it is a counterweight as it uses a minute amount of energy to pierce through the proximity of the slimmer magnet full force to the other side, but this intercepting piece can also be made of a drop less force and power or also become with added electricity into a drop less force and power so that when a minute amount of electricity is added to it, it will intercept the magnetic field, or that interception will get pierced from the main magnet, and the electric voltage path and direction can be going out or around [including back into the battery] as stated in claim 13 [and with the kinds of electricity as explained in claim 13 including with using only either electron or proton].

15: the magnetic force field energy/water device as part of claim 1, wherein the intercepting piece of the magnetic field is of a smaller magnetic force but it will be held at exact proximity to the facing magnet according to its force so that the magnetic field of the intercepting pieces force will be both up and down in this exact proximity such as a counterweight, and it can be pierced from magnetic force and/or intercept the magnetic field by going up and down or in and out, [and a magnetic piece that has only one of its polls facing outwards and/or electro magnetism may be used in this case also].

16: the magnetic force field energy/water device as part of claim 1 wherein the intercepting piece or pieces is so slim or thin the magnets force can not have any manipulation on it so its force becomes obscured and none, just as in a counterweight because the magnetic force has no hold on the very slim or thin piece, this can also be if it (the intercepting piece) is grind-ed or with a substance that can hold electricity (or magnetic power), so much so that I am not sure if I have to really make this claim a part of the field of chemistry and not physics.

17: The magnetic field force energy/water device wherein the intercepting piece can be done with chemistry, for there also maybe with ways of chemistry in literature found from the 17th century period many things that are believed to intercept or obscure the force of a magnetic field like diamond, sapphire, vinegar, fats, hot water, garlic etc. . . . none of them however where yet attached to a battery making energy and although the chances of it working now a days are very slim, there may be things believed in public literature to intercept or obscure all the kinds of magnetic fields [such as plastic magnets, certain acids, led or leather or even with the [new] elements etc. . . . ] that can still be patented as nobody has yet put it together with a battery yet so far.

18: The magnetic force field energy/water device as part of claim 1, wherein all or some of the claims are put together in one connection with each other, and wherein some or even all or two or more of the depicted and shown and/or discussed cases in this patent are put together in one conjunction to make energy, a battery, vehicle movement, or water, it will all be totally considered in the confines of this patent, and whether in all these cases depicted it is made to go around on a wheel or wheels, including any way of going partially around, and whether in all the cases depicted the metal can be magnet or the magnet can be metal, and whether in all the cases depicted opposing magnets can be non opposing magnets or vise versa, all of this also shall be totally considered in the confines of this patent, including also when and if in the cases depicted the intercepting piece itself can make electricity with or with out having to face other metals, and in all of the cases depicted the counterweight can be with all things known to counterweight and in any way of counterweight and also in all of the cases depicted metals means any kind of a metal even if its mixed metals like the new elements and with cases of electricity the electric current can be both of the ways.

19: The magnetic force field energy/water device as part of claim 1, wherein since obvious to those that know and understand the physics of magnetism, many a time the intercepting piece discussed in this patent will get stuck on the facing magnet, there will have to be something holding that intercepting piece in its path strongly from making a kind of mathematical leave of its line and place set to be, this can obviously be done in many ways and include putting it on wheels or any kind of tires, also included is another obvious thing of this patent, is that the counterweights will all have energy supply to make the movements that can be from a battery that can have connected with it all of today's known things and/or it [the counterweights or intercepting pieces] can get energy from the generator itself in all the ways that are known possible or that will become known possible [including with a long wire etc. . . . ] to make it proportional and/or timely, and also another obvious thing is wherein the magnet is held in mid air by anything that can hold it in mid air or where it the magnet or metal is held down by its own gravitational weight in all the cases and claims.

20: The magnetic force field energy/water device as part of claim 1, wherein in all of the cases depicted and discussed in this patent, the moving metal or magnets are connected to any kind or way of a generator known now or in the future, including a generator that is set to go on and off of the moving metals or in and out of it in all the ways of knowing how like by any kind or way of a button, a timer, a video, or any other way known including with a protruding piece that locks in one way and opens in the other, or that will be created, this includes if the moving metals themselves are set in this way, and it also includes on/with any kind or way of a generator and/or way to clean water via heating the water in all ways of making heat by rubbing things or other or any other way to clean water from movement and also generating electricity from inducement of the metal/magnets themselves in all the cases depicted in this patent.
